(19) United States
(12) Patent Application Publication
(10) Pub. No.: US 2020/0232268 A1
(43) Pub. Date: Jul. 23, 2020

(54) COMPOSITE DOOR AND WINDOW COMPONENT WITH A CO-EXTRUDED CORE AND AN IMPERMEABLE END BLOCK

(71) Applicant: Weston Wood Solutions Inc., Brampton (CA)

(72) Inventor: Guang Hui LI, Brampton (CA)

(73) Assignee: Weston Wood Solutions Inc., Brampton (CA)

(21) Appl. No.: 16/741,822

(22) Filed: Jan. 14, 2020

Related U.S. Application Data
(60) Provisional application No. 62/794,201, filed on Jan. 18, 2019.

(51) Int. Cl. E06B 1/32; E06B 3/08; E06B 3/30

(52) U.S. Cl. CPC E06B 1/32; E06B 3/302; E06B 3/08

(57) ABSTRACT

The present disclosure provides a frame component for a window or door that employs composite materials in a manner that is sufficiently structurally strong yet resists degradation due to unfavorable environmental conditions. In at least one embodiment the present disclosure provides a mullion for a frame for an opening having a core assembly having a longitudinally extending core and at least one end block, a first surface of the end block abutting a first end of the longitudinally extending core to result in the core assembly having a radial surface extending radially about the core assembly; and a longitudinally extending outer sheath, the longitudinally extending outer sheath enveloping the radial surface of the core assembly, an inner surface of the longitudinally extending outer sheath bonded to the radial surface of the core assembly in a continuous manner.

### FIELD

The present disclosure relates to building components. More specifically, the present disclosure relates to window or door component that can be used as a mullion, jamb or frame component for openings for doors or windows in residential and commercial construction.

### BACKGROUND

Mullions are commonly used building components in residential and commercial construction that are used to divide a frame for a rough opening into two or more separate openings. In some applications, a mullion may provide structural support to the door or window and the opening that it is installed in.

In many applications, such as certain types of openable doors and windows, mullions may provide a surface in which a window or door element can snugly abut against when in a closed position. Moreover, it is contemplated that a window or door element may be mounted directly to the mullion.

Accordingly, mullions and other frame components are subject to a number of structural stresses and as a result need to be designed and manufactured with sufficient consideration for these stresses. Moreover, in exterior applications, a mullion can experience physical degradation due to a variety of challenging environmental conditions, from sunlight damage, warping due to dry and humid air, rot and decay due to precipitation and moisture, insect and rodent damage and damage from thermal expansion due to freezing and ambient temperatures that can range more than 60 degrees Celsius.

In fact, many jurisdictions have specific building code requirements for door and windows in order to ensure that the resulting construction can withstand extreme weather conditions such as hurricanes and tropical storms.

Moreover, it will be readily appreciated that mullions are particularly vulnerable to degradation due to environmental factors at the end of the mullion where it interfaces with a frame component of a door or window, as water can penetrate or accumulate at this interface.

Wood (such as laminated veneer lumber) is a commonly used material for manufacturing mullions and other door and window components. Wood is strong when experiencing compressive, tensile, torsional and sheer stresses, is generally plentifully available, aesthetically appealing and easy to manufacture with. However, it will be readily appreciated that wood can be particularly vulnerable to the environmental factors listed above.

Polymer materials have been developed that can be far more durable than wood in the face of unfavorable environmental conditions. However, these types of materials often lack the structural strength, aesthetic appeal and ease of manufacture that wood provides. Polymer materials can also potentially be more affordable and environmentally sustainable than wood, depending on the particular materials used.

As such, composite door and window components manufactured out of both polymer and traditional wood are known which can foreseeably address some of the disadvantages that are present when using non-composite construction techniques. However, known methods for manufacturing composite components face unique challenges as it is quite difficult to securely and reliably integrate polymer materials with traditional materials (such as wood) in order to result in a sufficiently durable, cost-effective and resilient building components.

Accordingly, there is a need for a window or door component that can be used as a mullion and which employs composite construction in a manner that is sufficiently structurally strong yet resists degradation due to unfavorable environmental conditions.

### BRIEF SUMMARY

It is contemplated that the present disclosure provides a window or door component that can be used as a mullion and which employs composite construction in a manner that is sufficiently structurally strong yet resists degradation due to unfavorable environmental conditions.

In at least one embodiment it is contemplated that the present disclosure provides a mullion for a frame for an opening having a core assembly having a longitudinally extending core and at least one end block, a first surface of the at least one end block abutting an end of the longitudinally extending core to result in the core assembly having a radial surface extending radially about the core assembly, and a longitudinally extending outer sheath, the longitudinally extending outer sheath enveloping the radial surface of the core assembly, an inner surface of the longitudinally extending outer sheath bonded to the radial surface of the core assembly in a continuous manner.

In at least one embodiment it is contemplated that the present disclosure provides a kit for assembling a frame for an opening, the kit having at least one mullion, the at least one mullion having a core assembly having a longitudinally extending core and at least one end block, a first surface of the at least one end block abutting an end of the longitudinally extending core to result in the core assembly having a radial surface extending radially about the core assembly and a longitudinally extending outer sheath, the longitudinally extending outer sheath enveloping the radial surface of the core assembly, an inner surface of the longitudinally extending outer sheath bonded to the radial surface of the core assembly in a continuous manner, at least one side jamb member longitudinally extending between a first end and a second end, a header jamb member horizontally extending between a first end and a second end, and a sill member horizontally extending between a first end and a second end.

In at least one embodiment it is contemplated that the present disclosure provides a frame for an opening, the frame comprising at least one mullion, the at least one mullion having a core assembly having a longitudinally extending core and at least one end block, a first surface of the at least one end block abutting an end of the longitudinally extending core to result in the core assembly having a radial surface extending radially about the core assembly and a longitudinally extending outer sheath, the longitudinally extending outer sheath enveloping the radial surface of the core assembly, an inner surface of the longitudinally extending outer sheath bonded to the radial surface of the core assembly in a continuous manner, at least one side jamb member longitudinally extending between a first end and a second end, a header jamb member horizontally extending between a first end and a second end, and a sill member horizontally extending between a first end and a second end, such that the at least one mullion and the at least one side jamb member longitudinally extend between a lower surface of the header jamb member and an upper surface of the sill member, a lower surface of the end block abutting the upper surface of the sill member, a second end of the core abutting the lower surface of the header jamb member.

In at least one embodiment it is contemplated that the present disclosure provides a method for manufacturing a mullion, the method including the steps of mechanically securing at least one end of a longitudinally extending core to an upper surface of at least one end block to result in a core assembly having a radial surface extending radially about the core assembly, and extruding a longitudinally extending outer sheath about the core assembly, the longitudinally extending outer sheath enveloping the radial surface of the core assembly, an inner surface of the longitudinally extending outer sheath bonded to the radial surface of the core assembly in a continuous manner.

### DESCRIPTION OF THE FIGURES

The present disclosure will be better understood in connection with the following FIGURES, in which:

FIG. 1 is an exploded perspective view of a frame assembly incorporating a mullion in accordance with at least one embodiment of the present invention;

FIG. 2 is an assembled perspective view of the frame assembly of FIG. 1;

FIG. 3 is a cutaway perspective view of the mullion of FIG. 1;

FIG. 4 is a lower end view of the mullion of FIG. 1

FIG. 5 is a lower perspective view of the mullion of FIG. 1 where the outer sheath has been partially removed from the end block;

FIG. 6 is a lower perspective view of a mullion in accordance with another embodiment of the present invention; and

FIG. 7 is a cross sectional view of a jamb component in accordance with another embodiment of the present invention.

### DETAILED DESCRIPTION OF THE EMBODIMENTS

It is contemplated that the present disclosure provides a window or door component that can be used as a mullion or frame component and which employs composite construction in a manner that is sufficiently structurally strong yet resists degradation due to unfavorable environmental conditions.

It is contemplated that the presently disclosed apparatuses could be manufactured to any suitable dimensions by way of any suitable manufacturing technique, as will be appreciated by the skilled person.

In the context of the present disclosure, “composite materials” include but are not limited to suitable polymers, foams, plastics, fiberglasses and carbon fibres, as will be readily appreciated by the skilled person.

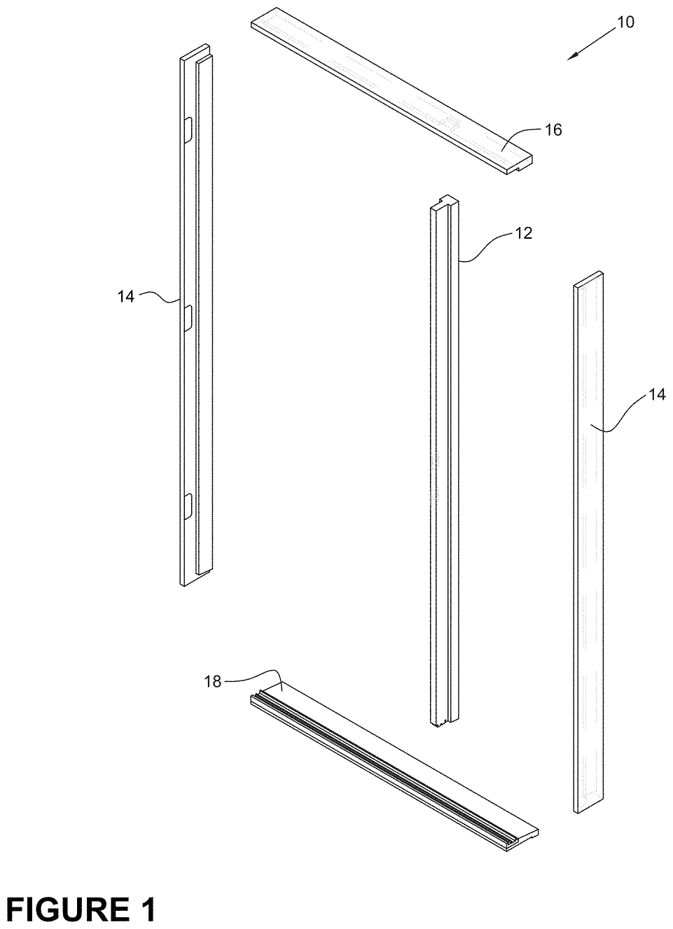

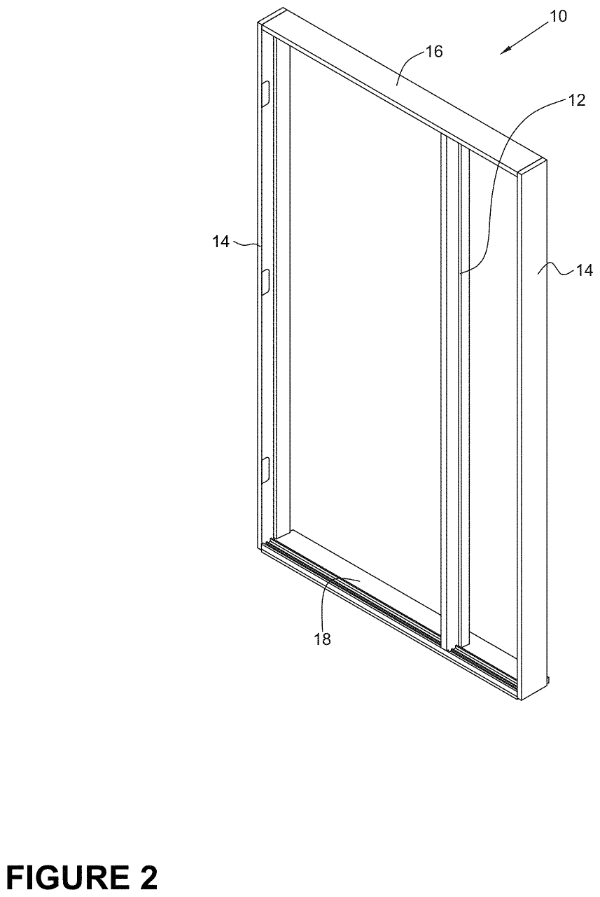

Turning to FIGS. 1 and 2, at least one embodiment of a frame assembly in accordance with the present invention is illustrated. In this embodiment, frame assembly 10 includes at least one mullion 12, at least one side jamb member 14, a header member 16 and a sill member 18.

It is contemplated that each of mullion 12, side jamb member 14, header member 16 and sill member 18 each longitudinally extend between a first end and a second end, as can be seen in FIGS. 1 and 2. It is contemplated that each of the mullion 12, side jamb member 14, header member 16 and sill member 18 could be formed of composite construction as disclosed herein.

Moreover, when frame assembly 10 is assembled, each mullion 12 and side jamb member 14 longitudinally extend between header member 16 and sill member 18 such that a respective first end of each mullion 12 and side jamb member 14 abut an upper surface of sill member 18 and a respective second end of each mullion 12 side member 14 abut a lower surface of header member 16.

It is contemplated that mullion 12, side jamb member 14, header member 16 and sill member 18 can be assembled to one another by any suitable means, including but not limited to adhesives and mechanical fasteners (such as but not limited to screws and nails).

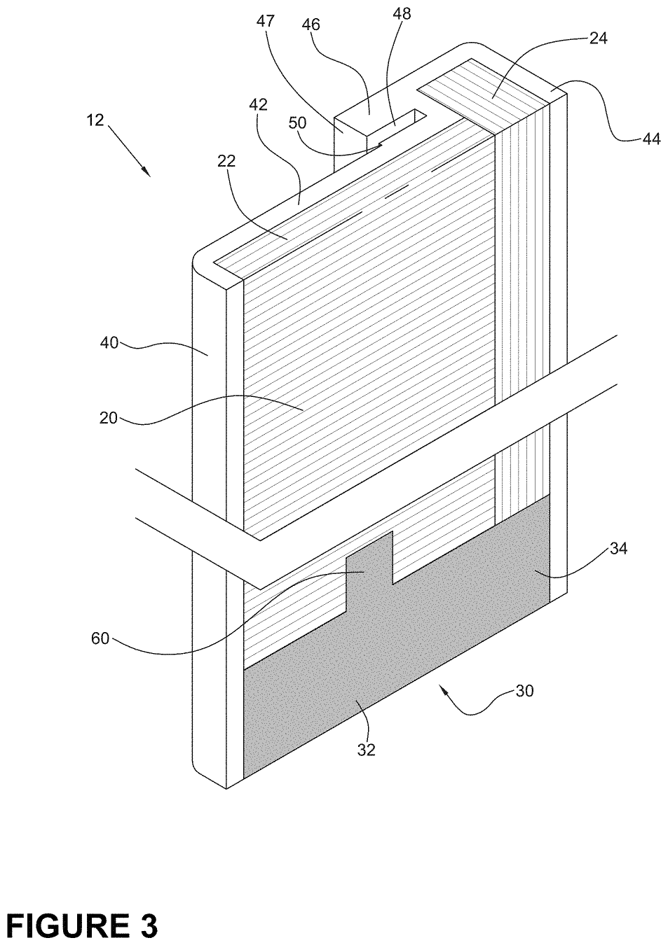

Turning to FIG. 3, a cross-sectional view of at least one embodiment of mullion 12 is illustrated. In this embodiment, mullion 12 includes a core 20, at least one end block 30 and an outer sheath 40. Together core 20 and end block 30 make up a core assembly. In this embodiment it is contemplated that there is only a single, lower end block 30, however it is also contemplated that two end blocks can be provided in the core assembly, one at each end of core 20.

In at least one embodiment, it is contemplated that core 20 can be constructed of laminated veneer lumber (LVL), however other materials such as Laminated Veneer Board (LVB), Laminated Strand Board (LSB) or aluminum are also contemplated. It is contemplated that core 20 can be a single, unitary component or can be formed of multiple separate components suitably joined together.

In at least one embodiment, core 20 includes a web section 22 and a perpendicularly oriented flange section 24. It is further contemplated that each of web section 22 and flange section 24 each have a respective first longitudinal edge, a second longitudinal edge, a first surface and a second surface.

In at least one embodiment it is contemplated that one of the longitudinal edges of web section 22 abuts one of the surfaces of flange section 24 in a perpendicular manner, such that core 20 has a generally “T-shaped” cross-sectional profile, as can be seen in FIG. 3.

Moreover, it is further contemplated that core 20 has an end that abuts end block 30. It is contemplated that core 20 can be joined to end block 30 in a continuous manner in a variety of ways using a variety of techniques, as will be discussed in further detail below. In at least one embodiment, it is contemplated that end block 30 is manufactured from an impermeable material such as polypropelene, however other suitably durable materials are also contemplated.

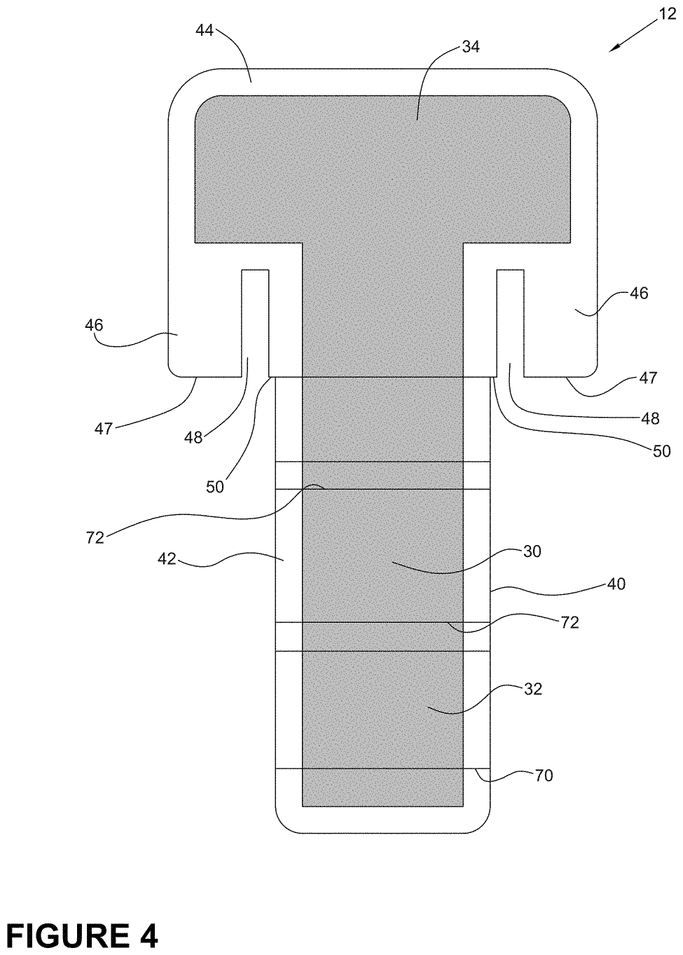

In some embodiments, it is contemplated that end block 30 further includes a flange section 32 and web section 34 arranged in a generally perpendicular manner to result in a “T-shaped” cross sectional profile in a matching and analogous manner to core 20 as discussed above and as can be seen in FIG. 4.

It is further contemplated that core 20 and end block 30 are enveloped in a radial manner by outer sheath 40. In at least one embodiment, it is contemplated that outer sheath 40 is manufactured from cellular PVC, however other suitably durable materials are also contemplated.

It is contemplated that outer sheath 40 radially envelops core 20 and end block 30 such that a respective end of core 20 and end block 30 are left exposed for mounting to a header jamb member and a sill member, as discussed herein in connection with FIGS. 1 and 2. Otherwise, it contemplated that outer sheath 40 fully envelops core 20 and end block 30 in a continuous manner such that core 20 and end block 30 are protected from any environmental elements that these components are exposed to.

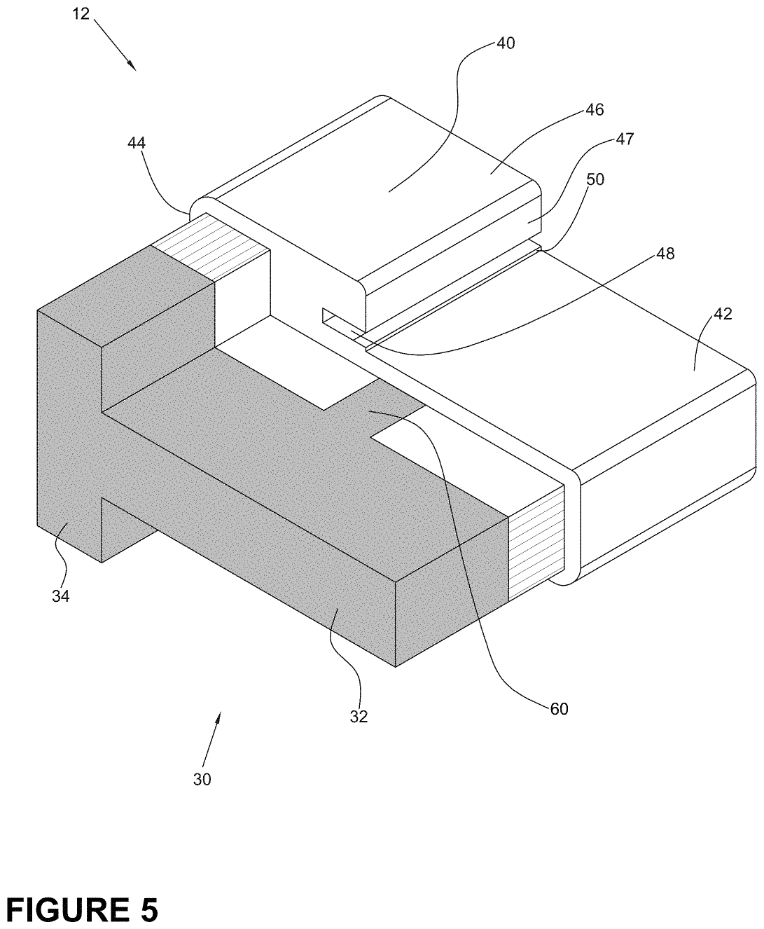

It is further contemplated that outer sheath 40 includes a web section 42 and a flange section 44 that each partially envelop the respective web sections and flange sections of core 20 and end block 30 such that the resulting outer sheath 40 fully envelops the radial surfaces of core 20 and end block 30 when mullion 12 is fully assembled, as will be discussed in further detail herein and as can be seen in FIG. 5.

It is further contemplated that flange section 44 of outer sheath 40 has a first longitudinal extending edge and a second longitudinally extending edge. It is further contemplated that each longitudinally extending edge can further include a longitudinally extending projecting flange 46. In at least one embodiment, it is contemplated that projecting flange 46 is oriented in a generally perpendicularly manner such that a longitudinally extending groove 48 is defined between projecting flange 46 and an outer surface of web section 42 of outer sheath 40.

Moreover, in some embodiments, it is contemplated that a longitudinally extending shoulder 50 is oriented on the outer surface of web section 42 of outer sheath 40 at a position adjacent and opposed from a distal edge 47 of projecting flange 46. In this way, projecting flange 46, the outer surface of web section 42 and shoulder 50 define groove 48 (as can be seen in FIGS. 3, 4 and 5) which can be utilized to receive a longitudinally extending weatherstripping component (not shown) as will be readily understood by the skilled person. In some embodiments, it is contemplated that the inner surfaces of groove 48 can be textured or grooved in order to assist the retention of the weatherstripping component.

Moreover, it will be appreciated that in some applications a door component (not shown) can abut the distal edge 47 of projecting flange 46 when installed.

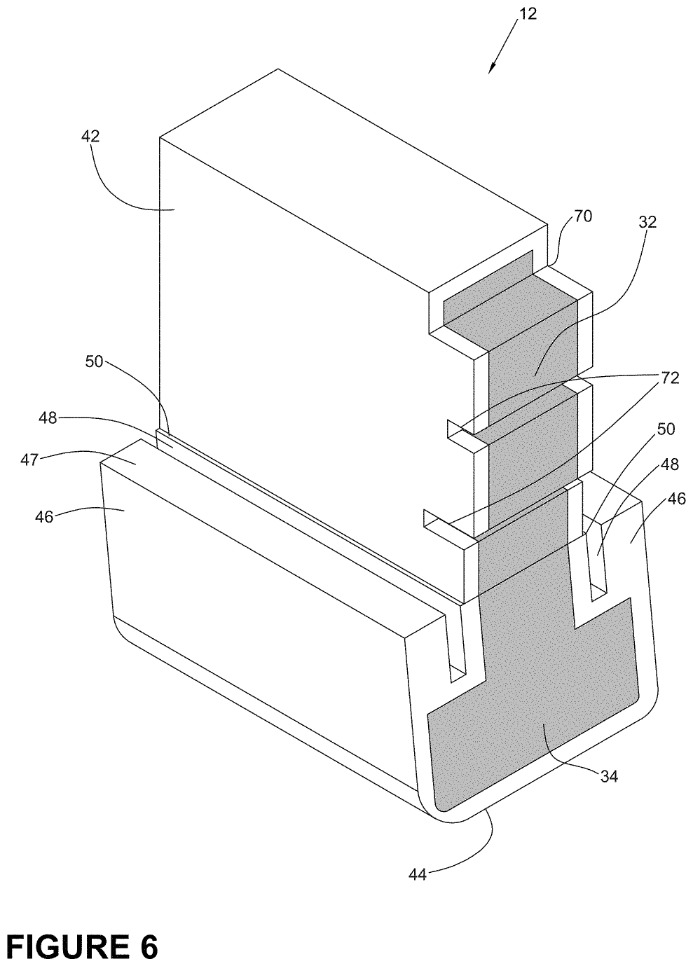

Turning to FIGS. 5 and 6, at least one embodiment of end block 30 is illustrated, wherein the outer sheath has been partially removed in FIG. 5. It will be appreciated that each of core 20 and end block 30 have respective web sections and flange section oriented in a generally perpendicular manner to result in matching “T-shaped” cross sectional profiles, as discussed herein.

In this embodiment, it is contemplated that end block 30 further includes an upwardly projecting securing element 60 projecting upwardly from a first end of end block 30 and can further include a downwardly projecting securing element (not shown) projecting downwardly from a second end of end block 30. In at least one embodiment it is contemplated that upwardly projecting securing element 60 is securely embedded in a first end of core 20 to secure end block 30 relative to core 20 as seen in FIG. 5.

It is further contemplated that a downwardly projecting securing element can be adapted to secure a sill member to the assembled mullion. It is further contemplated that the projecting securing elements can further include tangs or serrated elements to assist with gripping the core or sill member, as required by the particular end user application of the present mullion.

It is further contemplated that end block 30 can further include a securing plate disposed between a first end of end block 30 and a first end of core 20. In this embodiment, it is contemplated that the securing plate can include a projecting perimeter rim that is adapted to receive and be secured to at least one of the first end of end block 30 and a first end of core 20.

Turning to FIGS. 4 and 6, one embodiment of a first end of outer sheath 40 of mullion 12 is illustrated. In this embodiment, web section 42 of outer sheath 40 further includes a notch 70 in a longitudinal edge of web section 42 of outer sheath 40 at a position adjacent to a first end of mullion 12. It is contemplated that notch 70 can be generally perpendicular in arrangement and can provide access to the underlying end block when mullion 12 is assembled in connection with a sill member.

Moreover, it is contemplated that outer sheath 40 of mullion 12 can also include at least one upwardly extending slot 72 that is located in outer sheath 40 at a position adjacent a first end of mullion 12. It is contemplated that each upwardly projecting slot 72 can be generally perpendicular in arrangement and can provide access to the underlying end block when mullion 12 is assembled in connection with a sill member. In some embodiments, it is contemplated that both notch 70 at least one upwardly extending slot 72 also extend into end block 30.

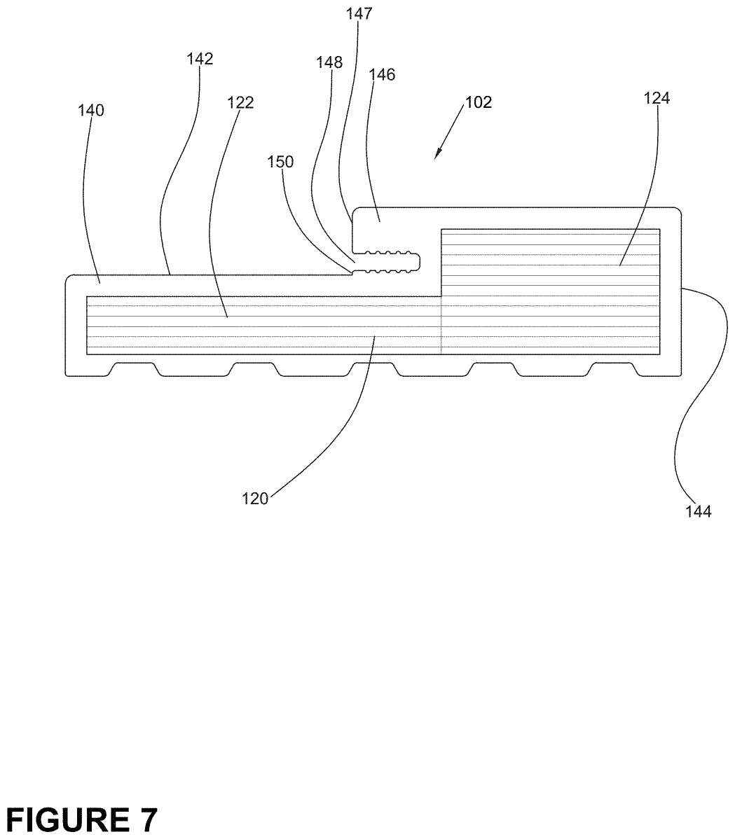

Turning to FIG. 7, a cross sectional view of a jamb component in accordance with the present invention is illustrated. In this embodiment, jamb component 102 includes a core 120, at least one end block (not shown) and an outer sheath 140. Together core 120 and the end block make up a core assembly. In this embodiment it is contemplated that there is only a single, lower end block, however it is also contemplated that two end blocks can be provided in the core assembly, one at each end of the core.

In at least one embodiment, it is contemplated that core 120 can be constructed of laminated veneer lumber (LVL), however other materials such as Laminated Veneer Board (LVB), Laminated Strand Board (LSB) or aluminum are also contemplated. It is contemplated that core 120 can be a single, unitary component or can be formed of multiple separate components suitably joined together.

In at least one embodiment, core 20 includes a web section 22 and a perpendicularly oriented flange section 24. It is further contemplated that each of web section 22 and flange section 24 each have a respective first longitudinal edge, a second longitudinal edge, a first surface and a second surface.

In at least one embodiment it is contemplated that one of the longitudinal edges of web section 122 abuts one of the surfaces of flange section 124 in a perpendicular manner, such that core 120 has a generally “L-shaped” cross-sectional profile, as can be seen in FIG. 7.

Moreover, it is further contemplated that core 120 has an end that abuts the end block. It is contemplated that core 120 can be joined to the end block in a continuous manner in a variety of ways using a variety of techniques, as will be discussed in further detail below. In at least one embodiment, it is contemplated that the end block is manufactured from an impermeable material such as polypropelene, however other suitably durable materials are also contemplated.

It is further contemplated that core 120 and the end block are enveloped in a radial manner by outer sheath 140. In at least one embodiment, it is contemplated that outer sheath 140 is manufactured from cellular PVC, however other suitably durable materials are also contemplated.

It is contemplated that outer sheath 140 radially envelops core 120 and the end block such that a respective end of core 120 and the end block are left exposed for mounting to a header jamb member and a sill member, as discussed herein in connection with FIGS. 1 and 2. Otherwise, it contemplated that outer sheath 140 fully envelops core 120 and the end block in a continuous manner such that core 120 and the end block are protected from any environmental elements that these components are exposed to.

It is further contemplated that outer sheath 140 includes a web section 142 and a flange section 144 that each partially envelop the respective web sections and flange sections of core 120 and the end block such that the resulting outer sheath 140 fully envelops the radial surfaces of core 120 and the end block when jamb 102 is fully assembled.

It is further contemplated that flange section 144 of outer sheath 140 has a first longitudinal extending edge. It is further contemplated that this longitudinally extending edge can further include a longitudinally extending projecting flange 146. In at least one embodiment, it is contemplated that projecting flange 146 is oriented in a generally perpendicularly manner such that a longitudinally extending groove 148 is defined between projecting flange 146 and an outer surface of web section 142 of outer sheath 140.

Moreover, in some embodiments, it is contemplated that a longitudinally extending shoulder 150 is oriented on the outer surface of web section 142 of outer sheath 140 at a position adjacent and opposed from a distal edge 147 of projecting flange 146. In this way, projecting flange 146, the outer surface of web section 142 and shoulder 150 define groove 148 (as can be seen in FIG. 7) which can be utilized to receive a longitudinally extending weatherstripping component (not shown) as will be readily understood by the skilled person. In some embodiments, it is contemplated that the inner surfaces of groove 148 can be textured or grooved in order to assist the retention of the weatherstripping component.

Moreover, it will be appreciated that in some applications a door component (not shown) can abut the distal edge 147 of projecting flange 146 when installed.

In this embodiment, it is contemplated that an opposing outer surface of web section 142 of outer sheath 140 can include at least one longitudinally extending groove 160. In some embodiments it is contemplated that groove 160 can have a semicircular cross-sectional profile as seen in FIG. 7.

Manufacturing the Mullion

It is contemplated that a mullion in accordance with the present disclosure can be manufactured as follows.

First, it is contemplated that the core 20 can be mechanically fastened to an upper surface of the end block 30, as can be seen in FIG. 3. As discussed herein, it is contemplated that a securing plate can be provided that has a projecting perimeter rim that is adapted to receive and be secured to at least one of the first end of end block 30 and a first end of core 20. It is further contemplated an upwardly and/or downwardly projecting securing elements can be provided on end block 30 that projects into a suitable sized bore provided in core 20 to secure core 20 relative to end block 30.

Next, it is contemplated that an outer sheath 40 can be extruded about the core assembly (or in other words, the core mechanically fastened to the end block) such that an inner surface of outer sheath 40 is securely and continuously bonded to the radial surface of the core assembly. In other words, the outer sheath fully envelops the core assembly but does not cover or envelop the end surfaces of the core assembly (that is, the upper end of core 20 and the lower surface of end block 30). In some embodiments, it is further contemplated that a notch 70 and/or at least one slot 72 can be cut in at least one end of mullion 12.

In this way, the exposed ends of the core assembly can be fastened or connected to other frame components as discussed herein. Moreover, it will be readily appreciated that at least the lower end of mullion 12 (and in some embodiments, both ends of mullion 12) are sealed from the elements. Further, it is contemplated that the resulting mullion has a continuous bond between the core assembly (which is made up of the core and at least one end block suitably fastened together) and the outer sheath, resulting in a mullion that is particularly impervious to moisture and water damage, sufficiently strong when subjected to compressive, tensile, torsional and shear stresses and can be manufactured in an economical manner.

The embodiments described herein are intended to be illustrative of the present compositions and methods and are not intended to limit the scope of the present disclosure. Various modifications and changes consistent with the description as a whole and which are readily apparent to the person of skill in the art are intended to be included. The appended claims should not be limited by the specific embodiments set forth in the examples but should be given the broadest interpretation consistent with the description as a whole.

1. A mullion for a frame for an opening comprising:
A core assembly comprising, a longitudinally extending core and at least one end block, a first surface of the at least one end block abutting an end of the longitudinally extending core to result in the core assembly having a radial surface extending radially about the core assembly; and
A longitudinally extending outer sheath, the longitudinally extending outer sheath enveloping the radial surface of the core assembly, an inner surface of the longitudinally extending outer sheath bonded to the radial surface of the core assembly in a continuous manner.

2. The mullion of claim 1 wherein the longitudinally extending core is further comprised of a longitudinally extending web having a first longitudinally extending edge that abuts a first longitudinally extending surface of a longitudinally extending flange.

3. The mullion of claim 1, wherein the longitudinally extending outer sheath further comprises:
A longitudinally extending flange section extending laterally between a first longitudinal edge and a second longitudinal edge, the longitudinally extending flange section partially enveloping a radial surface of the longitudinally extending flange of the longitudinally extending core;
A longitudinally extending web section, the web section abutting the longitudinally extending flange section in a T-shaped cross-sectional arrangement, the longitudinally extending web section partially enveloping a radial surface of the longitudinally extending web of the longitudinally extending core.

4. The mullion of claim 1 wherein the longitudinally extending flange section further comprising a first projecting flange that projects from the first longitudinal edge and a second projecting flange that projects from the second longitudinal edge, the first projecting flange and the second projecting flange oriented parallelly to the longitudinally extending web section, the first projecting flange defining a first groove between the first projecting flange and a first outer surface of the longitudinally extending web section, the second projecting flange and the second projecting flange defining a second groove between the second projecting flange and a second outer surface of the longitudinally extending web section.

5. The mullion of claim 1 wherein at least one of the first outer surface and the second outer surface further comprises a longitudinally extending shoulder, the longitudinally extending shoulder located from at least one of a longitudinally extending distal edge of the first projecting flange and longitudinally extending distal edge of the second projecting flange.

6. The mullion of claim 1 wherein the end block further comprises a mounting plate, the mounting plate adapted to mechanically secure the end block to the core.

7. The mullion of claim 1 wherein the end block further comprises at least one upwardly projecting securing element, the at least one upwardly projecting securing element embedded in a first end of the longitudinally extending core and securing the end block to the longitudinally extending core.

8. The mullion of claim 1 wherein the end block further comprises at least one downwardly projecting securing element.

9. The mullion of claim 1 wherein a first end of the longitudinally extending outer sheath further comprises a notch, the notch located adjacent to a longitudinally extending edge of the longitudinally extending outer sheath.

10. The mullion of claim 1 wherein a first end of the longitudinally extending outer sheath further comprises at least one upwardly extending slot, the at least one upwardly extending slot extending upwardly from the first end of the longitudinally extending outer sheath.

11-20. (canceled)

21. A frame for an opening, the frame comprising:
at least one mullion, the at least one mullion comprising:
A core assembly comprising, a longitudinally extending core and at least one end block, a first surface of the at least one end block abutting an end of the longitudinally extending core to result in the core assembly having a radial surface extending radially about the core assembly; and
A longitudinally extending outer sheath, the longitudinally extending outer sheath enveloping the radial surface of the core assembly, an inner surface of the longitudinally extending outer sheath bonded to the radial surface of the core assembly in a continuous manner;
At least one side jamb member longitudinally extending between a first end and a second end;
A header jamb member horizontally extending between a first end and a second end; and
A sill member horizontally extending between a first end and a second end,
Wherein the at least one mullion and the at least one side jamb member longitudinally extend between a lower surface of the header jamb member and an upper surface of the sill member, a lower surface of the end block abutting the upper surface of the sill member, a second end of the core abutting the lower surface of the header jamb member.

22. The frame of claim 21 wherein the longitudinally extending core is further comprised of a longitudinally extending web having a first longitudinally extending edge that abuts a first longitudinally extending surface of a longitudinally extending flange.

23. The frame of claim 21 wherein the longitudinally extending outer sheath further comprises:
A longitudinally extending flange section extending laterally between a first longitudinal edge and a second longitudinal edge, the longitudinally extending flange section partially enveloping a radial surface of the longitudinally extending flange of the longitudinally extending core;
A longitudinally extending web section, the web section abutting the longitudinally extending flange section in a T-shaped cross-sectional arrangement, the longitudinally extending web section partially enveloping a radial surface of the longitudinally extending web of the longitudinally extending core.

24. The frame of claim 23 wherein the longitudinally extending flange section further comprising a first projecting flange that projects from the first longitudinal edge and a second projecting flange that projects from the second longitudinal edge, the first projecting flange and the second projecting flange oriented parallelly to the longitudinally extending web section, the first projecting flange defining a first groove between the first projecting flange and a first outer surface of the longitudinally extending web section, the second projecting flange and the second projecting flange defining a second groove between the second projecting flange and a second outer surface of the longitudinally extending web section.

25. The frame of claim 21 wherein at least one of the first outer surface and the second outer surface further comprises a longitudinally extending shoulder, the longitudinally extending shoulder located from at least one of a longitudinally extending distal edge of the first projecting flange and longitudinally extending distal edge of the second projecting flange.

26. The frame of claim 21 wherein the end block further comprises a mounting plate, the mounting plate adapted to mechanically secure the end block to the core.

27. The frame of claim 21 wherein the end block further comprises at least one upwardly projecting securing element, the at least one upwardly projecting securing element embedded in a first end of the longitudinally extending core and securing the end block to the longitudinally extending core.

28. The frame of claim 21 wherein the end block further comprises at least one downwardly projecting securing element.

29. The frame of claim 21 wherein a first end of the longitudinally extending outer sheath further comprises a notch, the notch located adjacent to a longitudinally extending edge of the longitudinally extending outer sheath.

30. The frame of claim 21 wherein a first end of the longitudinally extending outer sheath further comprises at least one upwardly extending slot, the at least one upwardly extending slot extending upwardly from the first end of the longitudinally extending outer sheath.

31. A method for manufacturing a frame component, the method comprising the steps of:
mechanically securing at least one end of a longitudinally extending core to an upper surface of at least one end block to result in a core assembly having a radial surface extending radially about the core assembly; and
extruding a longitudinally extending outer sheath about the core assembly, the longitudinally extending outer sheath enveloping the radial surface of the core assembly, an inner surface of the longitudinally extending outer sheath bonded to the radial surface of the core assembly in a continuous manner.

32. The method of claim 31 further comprising the step of:
Cutting at least one of a notch and at least one slot in at least one end of the frame component.
